(19) United States
(12) Patent Application Publication
(10) Pub. No.: US 2020/0037513 A1
(43) Pub. Date: Feb. 6, 2020

(54) HYDROPONIC CULTIVATION SYSTEM AND LIGHT-EMITTING APPARATUS

(71) Applicant: Toshiaki HIRANO, Shizuoka (JP)

(72) Inventor: Toshiaki HIRANO, Shizuoka (JP)

(21) Appl. No.: 16/518,302

(22) Filed: Jul. 22, 2019

(30) Foreign Application Priority Data
Jul. 31, 2018 (JP) 2018-144138

(51) Int. Cl. A01G 9/24; F21K 9/20

(52) U.S. Cl. CPC A01G 9/249; F21Y 2115/10; F21K 9/20

(57) ABSTRACT

A cultivation system includes a light-emitting apparatus and an installation stand configured to accommodate a plurality of irradiation targets which are to be irradiated with light emitted from the light-emitting apparatus. The light-emitting apparatus includes a drive circuit, an electrically conductive member connected to the drive circuit and extending in a predetermined direction, a plurality of first members configured to be disposed at desired positions of the electrically conductive member, each of the plurality of first members including a light source, and a holder configured to hold the plurality of first members in a state where the plurality of first members are disposed at the desired positions of the electrically conductive member. The installation stand defines a plurality of installation place in which the plurality of irradiation targets are accommodated, respectively.

### CROSS-REFERENCE TO RELATED APPLICATION

This patent application is based on and claims priority under 35 U.S.C. § 119(a) to Japanese Patent Application No. 2018-144138, filed on Jul. 31, 2018, the entire disclosure of which is incorporated herein by reference.

### BACKGROUND

### Technical Field

The present disclosure relates to a cultivation system and a light-emitting apparatus.

### Description of the Related Art

In plant cultivation by a hydroponic cultivation system, a method is known in which plants are transplanted to an installation tray having a wider interval between plants to be cultivated according to the growth state of the plants. With this method, even when the plants grow, the leaves of the plants rarely or never overlap and shade each other, which allows the plants to absorb light efficiently.

### SUMMARY

Embodiments of the present disclosure describe a cultivation system including a light-emitting apparatus and an installation stand configured to accommodate a plurality of irradiation targets which are to be irradiated with light emitted from the light-emitting apparatus. The light-emitting apparatus includes a drive circuit, an electrically conductive member connected to the drive circuit and extending in a predetermined direction, a plurality of first members configured to be disposed at desired positions of the electrically conductive member, each of the plurality of first members including a light source, and a holder configured to hold the plurality of first members in a state where the plurality of first members are disposed at the desired positions of the electrically conductive member. The installation stand defines a plurality of installation place in which the plurality of irradiation targets are accommodated, respectively.

### BRIEF DESCRIPTION OF THE SEVERAL VIEWS OF THE DRAWINGS

A more complete appreciation of the embodiments and many of the attendant advantages and features thereof can be readily obtained and understood from the following detailed description with reference to the accompanying drawings, wherein:

FIG. 1 is a schematic diagram illustrating an example of a hydroponic cultivation system, according to an embodiment of the present disclosure;

FIG. 2 is a plan view illustrating an example of an installation stand of the cultivation system illustrated in FIG. 1;

FIG. 3 is a perspective view of an example of an irradiation apparatus, according to an embodiment of the present disclosure;

FIG. 4 is a perspective view of the irradiation apparatus viewed from a different angle from the view of FIG. 3;

FIG. 5 illustrates front views of examples of a first member, a second member and a third member of the irradiation apparatus illustrated in FIG. 3;

FIG. 6 illustrates plan views of the first member, the second member and the third member illustrated in FIG. 5;

FIG. 7 illustrates bottom views of the first member, the second member and the third member illustrated in FIG. 5;

FIG. 8 is a perspective view of an example of a case of the irradiation apparatus illustrated in FIG. 3;

FIG. 9 is a right side view of the case illustrated in FIG. 8;

FIG. 10 is a circuit diagram of the irradiation apparatus illustrated in FIG. 3;

FIG. 11 is a diagram illustrating an example a state before changing an interval between light sources, according to an embodiment of the present disclosure;

FIG. 12 is a diagram illustrating an example of a state after changing the interval between light sources, according to an embodiment of the present disclosure;

FIG. 13A to FIG. 13C are diagrams each illustrating another example of the first member illustrated in FIG. 5;

FIG. 14 is a right side view of another example of the case illustrated in FIG. 8;

FIG. 15 is a plan view of a variation of an electrically conductive member, according to an embodiment of the present disclosure;

FIG. 16 is a perspective view of the electrically conductive member illustrated in FIG. 15;

FIG. 17 illustrates bottom views of variations of the first member, the second member and the third member, according to an embodiment of the present disclosure;

FIG. 18 is a perspective view of the irradiation apparatus including the electrically conductive member illustrated in FIG. 15 and the first member, the second member and the third member illustrated in FIG. 17;

FIG. 19 is a view illustrating an example of a connection state of a circuit wiring and electrodes on the first member, the second member and the third member illustrated in FIG. 17;

FIG. 20A and FIG. 20B are left side views of a variation of a holder, according to an embodiment of the present disclosure;

FIG. 21 is a perspective view of an example of the irradiation apparatus including the holder illustrated in FIG. 20A and FIG. 20B;

FIG. 22 is a left side view of the irradiation apparatus illustrated in FIG. 21;

FIG. 23 is a front view of still another example of the first member, according to an embodiment of the present disclosure; and

FIG. 24 is a diagram illustrating an example where plants are moved.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

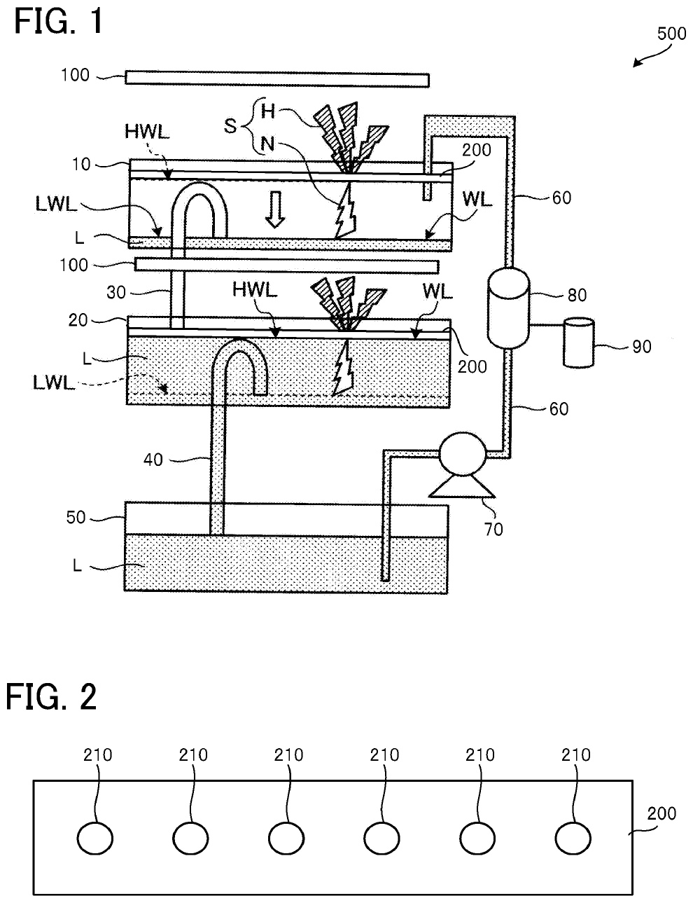

FIG. 1 is a diagram illustrating an example of a hydroponic cultivation system 500 according to the present disclosure. The hydroponic cultivation system 500 is an example of a cultivation system.

As illustrated in FIG. 1, the hydroponic cultivation system 500 includes a cultivation tank 10 and a cultivation tank 20. The cultivation tank 20 is disposed in the lower side of the hydroponic cultivation system 500 compared to the cultivation tank 10. The cultivation tank 10 and the cultivation tank 20 have the same capacity and are connected with each other via a siphon 30. Each of the cultivation tank 10 and the cultivation tank 20 is configured to store nutrient solution L in the lower part in the tank. In the present embodiment, a liquid containing water as the main component and further containing nutrient is used as the nutrient solution L. However, such liquid is just one example of the nutrient solution L. Alternatively, the nutrient solution can be water or any other suitable liquid that contains water as a component other than the main component.

Each of the cultivation tank 10 and the cultivation tank 20 includes an installation tray 200 for a plant or plants S grown with the nutrient solution L. The installation tray is an example of an installation stand. The installation tray 200 is arranged in the upper part of each of the cultivation tank 10 and the cultivation tank 20. The plant S is a plant having leaves H and roots N. In the present embodiment, it is assumed that the plant S is leaf vegetables such as lettuce and spinach. Although FIG. 1 illustrates a case where one plant S is accommodated in the installation tray 200, in fact, a plurality of plants S are accommodated in the installation tray 200.

As illustrated in FIG. 2, the installation tray 200 defines a plurality of holes 210, each being an installation place where the plants S is accommodated. In other words, the installation tray 200 includes the plurality of holes 210 corresponding to the plurality of plants S, respectively. The plant S is accommodated in the cultivation tank 10 and the cultivation tank 20 by inserting the roots N into the hole 210. Although in the present embodiment the drawing illustrates a case in which six holes 210 are provided in the installation tray 200, this is just an example. Any suitable number of the holes 210 can be provided according to the growth stage of the plant S, the type of the plant S, and the size of each of the cultivation tank 10 and the cultivation tank 20.

The hydroponic cultivation system 500 further includes a reservoir 50 configured to store the nutrient solution L. The reservoir 50 is provided below the cultivation tank 20 and connected to the cultivation tank 20 via a siphon 40.

The reservoir 50 is further connected to the cultivation tank 10 via a circulation pipe 60. A nutrient solution pump 70 and a bubble generator 80 are provided in the middle of the circulation pipe 60. By operating the nutrient solution pump 70, the nutrient solution L in the reservoir 50 is supplied to the cultivation tank 10 through the circulation pipe 60.

The bubble generator 80 is provided downstream from the nutrient solution pump 70 in the nutrient solution flowing direction. The bubble generator 80 receives a supply of gas from a gas tank 90 and generates bubbles in the nutrient solution L. As a bubble generation system, a cavitation system or a pressure dissolution system is used, for example.

The hydroponic cultivation system 500 further includes two plant irradiation apparatuses 100 that are provided above the cultivation tank 10 and the cultivation tank 20, respectively. The plant irradiation apparatuses 100 emit light onto the entire top surfaces of the cultivation tank 10 and the cultivation tank 20, respectively, that is, the plants S accommodated in the cultivation tank 10 and the cultivation tank 20, respectively. The plant irradiation apparatus 100 is an example of a light-emitting apparatus. Each plant S is an example of an irradiation target.

The siphon 30 is a pipe curved in an inverted J shape when viewed from the side. The siphon 30 includes a water intake and a drain outlet at both ends. The water intake is provided at a lower limit water level LWL that is set near the bottom of the cultivation tank 10. For example, the water intake is provided at the same level as the lower end of the roots N. The drain outlet is provided inside the cultivation tank 20. The top of the siphon 30 is located at an upper limit water level HWL that is set at the height of the boundary between the leaf H and the roots N of the plant S.

The siphon 40 is provided in substantially the same manner as the siphon 30. In other words, a water intake of the siphon 40 is provided at a lower limit water level LWL that is set near the bottom of the cultivation tank 20. A drain outlet of the siphon 40 is provided inside the reservoir 50. The top of the siphon 40 is located at an upper limit water level HWL that is set at the height of the boundary between the leaf H and the roots N of the plant S.

In the hydroponic cultivation system 500, the siphon 30 and the siphon 40 are alternately filled with the nutrient solution L by turning on and off the nutrient solution pump 70 at a predetermined timing. Further, the nutrient solution L is drained by siphoning from the siphon 30 and the siphon 40 alternately. Accordingly, the water levels WL of the nutrient solution L in the cultivation tank 10 and the cultivation tank 20 are alternately raised and lowered. When the water level WL is raised and lowered between the upper limit water level HWL and the lower limit water level LWL in each of the cultivation tank 10 and the cultivation tank 20, a state in which the roots N of the plant S are immersed in the nutrient solution L and another state in which the roots N are exposed above the nutrient solution L are repeated. In the present embodiment, the time period during which the roots N of the plant S are exposed above the nutrient solution L is set to be longer than the time period during which the roots N are immersed in the nutrient solution L.

A detailed description is now given of the above-described operation procedure.

As illustrated in FIG. 1, when the water level WL of the nutrient solution L in the cultivation tank 10 reaches the lower limit water level LWL, automatic drainage from the cultivation tank 10 to the cultivation tank 20 through the siphon 30 is stopped. On the other hand, when the water level WL of the nutrient solution L in the cultivation tank 20 reaches the upper limit water level HWL, the siphon 40 is filled with the nutrient solution L and automatic drainage by siphoning is started. Thus, the nutrient solution L in the cultivation tank 20 is drained to the reservoir 50 through the siphon 40.

At the time when the automatic drainage from the siphon 30 is stopped, or after the automatic drainage from the siphon 30 is stopped, the nutrient solution pump 70 is turned on and operated. Supply of the nutrient solution L from the reservoir 50 to cultivation tank 10 is started through the circulation pipe 60, thereby causing the water level WL of cultivation tank 10 to rise. Bubbles generated by the bubble generator 80, such as micro bubbles or ultra-fine bubbles are mixed in the nutrient solution L. On the other hand, the water level WL of the cultivation tank 20 falls by the automatic drainage through the siphon 40. When the water level WL of the cultivation tank 20 reaches the lower limit water level LWL, the siphoning is stopped, and the automatic drainage from the cultivation tank 20 to the reservoir 50 is stopped.

When the water level WL of the cultivation tank 10 reaches the upper limit water level HWL, the siphon 30 is filled with the nutrient solution L and accordingly, automatic drainage by siphoning is started. Thus, the nutrient solution L in the cultivation tank 10 is drained to the cultivation tank 20 through the siphon 30.

At the time when the automatic drainage by the siphon 30 is stopped or after the automatic drainage by the siphon 30 is stopped, the nutrient solution pump 70 is turned off to stop the operation. Thus, the supply of the nutrient solution L from the circulation pipe 60 to the cultivation tank 10 is stopped. By repeatedly turning the nutrient solution pump 70 on and off as described in the above procedure, the water level WL of the nutrient solution L in the cultivation tank 10 and the cultivation tank 20 is alternately raised and lowered between the upper limit water level HWL and the lower limit water level LWL.

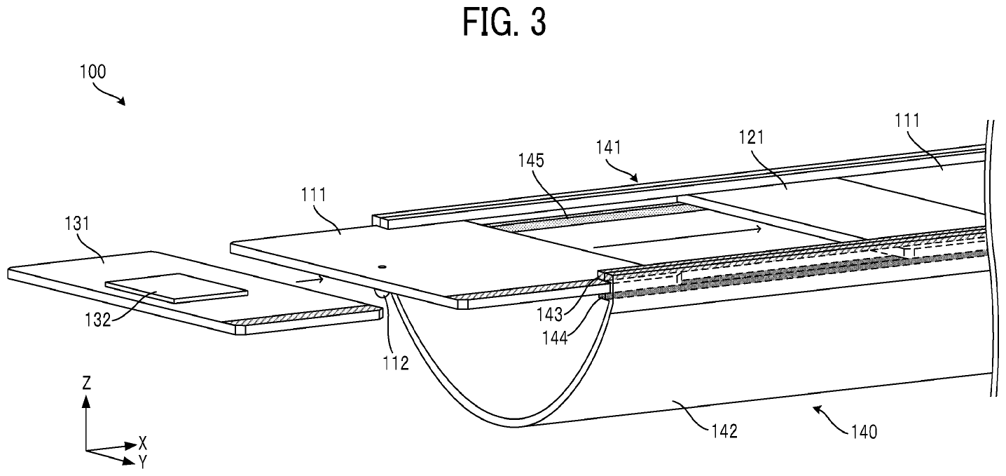

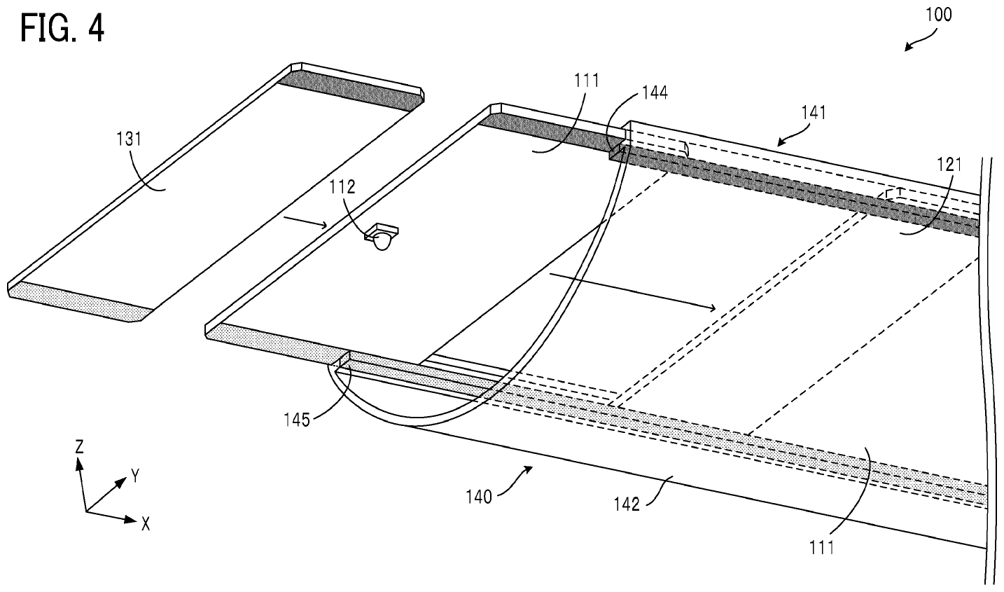

FIG. 3 and FIG. 4 are views each illustrating an example of each plant irradiation apparatus 100, according to an embodiment of the present disclosure. The plant irradiation apparatus 100 is long in an X direction indicated by an arrow X in FIG. 3. The X direction is an example of a predetermined direction. The plant irradiation apparatus 100 extends in the X direction. The X direction corresponds to a left-right direction of FIG. 1. In FIG. 3 and subsequent figures, the X direction indicates the left-right direction of the plant irradiation apparatus 100. A Y direction indicated by an arrow Y indicates a front-back direction of the plant irradiation apparatus 100. A Z direction indicated by an arrow Z indicates an up-down direction of the plant irradiation apparatus 100.

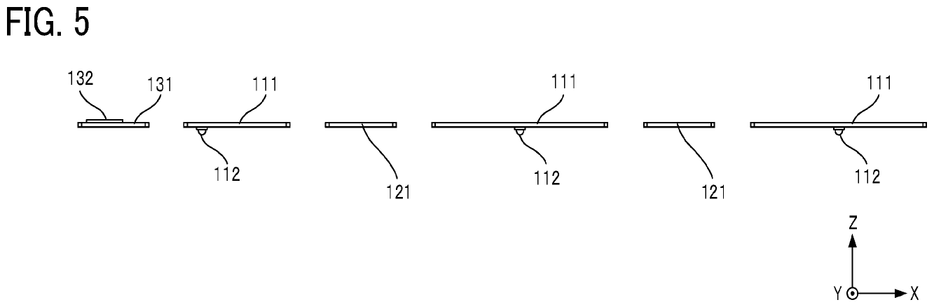

As illustrated in FIG. 3, FIG. 4 and FIG. 5, each plant irradiation apparatus 100 includes a plurality of first members 111. Each first member 111 includes a light emitting diode (LED) 112 as an example of a light source.

The plant irradiation apparatus 100 further includes a plurality of second members 121. Each second member 121 includes no LED.

The plant irradiation apparatus 100 further includes a third member 131 including an LED driver 132 as a drive circuit of the LED 112.

The plant irradiation apparatus 100 further includes a case 140 made of resin. The case 140 fixes positions of the first member 111, the second member 121, and the third member 131 accommodated therein.

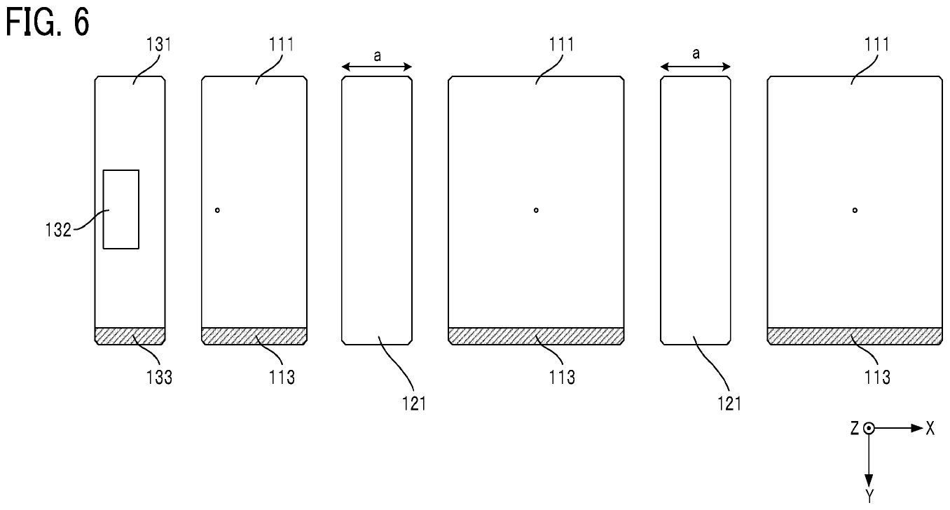

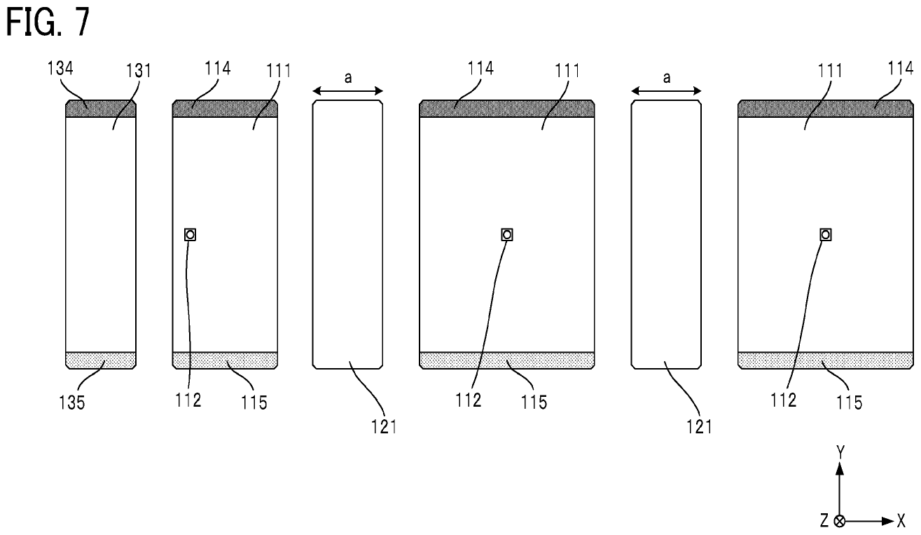

The first member 111 is a so-called electronic circuit board. As illustrated in FIG. 6 and FIG. 7, the first member 111 includes a ground 113, a positive electrode 114, and a negative electrode 115. The LED 112 is electrically connected to the ground 113, the positive electrode 114, and the negative electrode 115. A portion of the surface of the first member 111 is reflective, the portion excluding the ground 113, the positive electrode 114 and the negative electrode 115. For example, the surface of the first member 111, excluding the ground 113, the positive electrode 114 and the negative electrode 115 is covered with a white resist.

The interval between the LEDs 112 in the X direction can be changed by changing the positions of the first members 111 in the X direction.

Each second member 121 has a width “a” in the X direction. The width “a” can be set to a desired value. The second member 121 is interposed between two first members 111 or between a first member 111 and a third member 131. By arranging the second members 121 in this way, the interval between the LEDs 112 in the X direction is set to a desired width by adjusting the width “a”.

The second member 121 reflects light from the LED 112 toward the plant S. That is, the second member 121 has a reflective surface.

The second member 121 can be made of any suitable material, rather than material for an electronic circuit board, provided that the second member 121 has a reflective surface and the same thickness as the first member 111 and the third member 131. In addition, the plant irradiation apparatus 100 may include only one second member 121.

Similar to the first member 111, the third member 131 is an electronic circuit board having a reflective surface. The third member 131 includes a ground 133, a positive electrode 134, and a negative electrode 135. The LED driver 132 is electrically connected to the ground 133, the positive electrode 134, and the negative electrode 135.

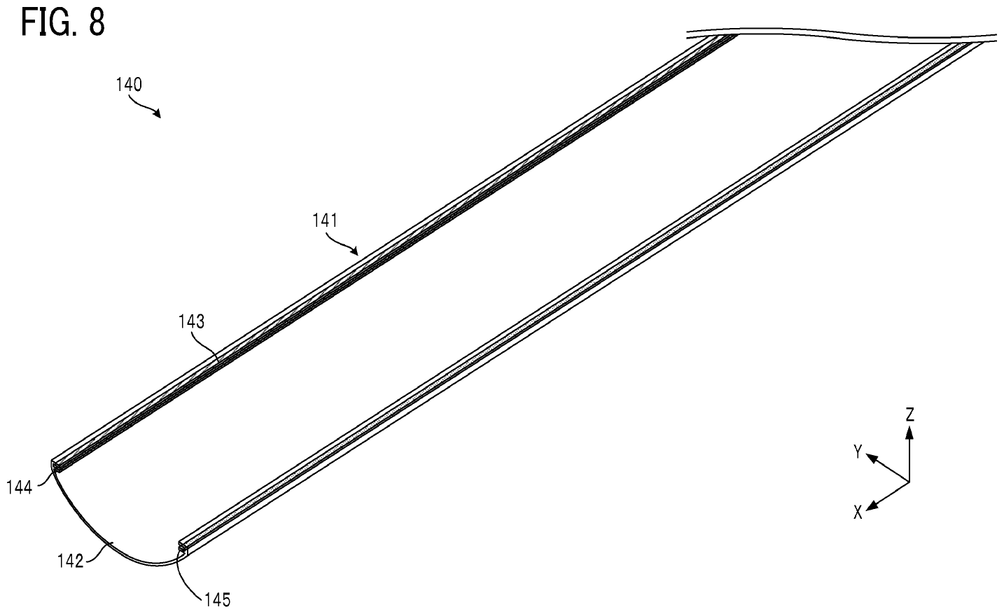

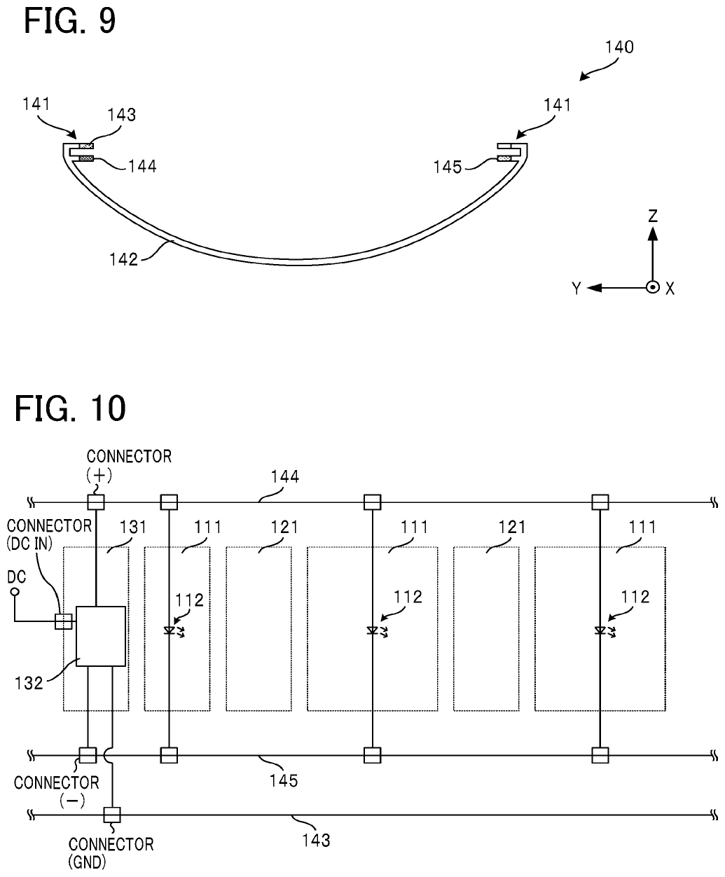

As illustrated in FIG. 8 and FIG. 9, the case 140 has a slide rail 141 that holds the first members 111, the second members 121 and the third member 131 such that the members can slide in the X direction. The slide rail 141 is an example of a holder.

The case 140 has a cover member 142 that protects the first members 111 and the third member 131 from water and dust.

The case 140 includes a ground 143, a positive electrode 144, and a negative electrode 145, each extending in the X direction. The ground 143, the positive electrode 144, and the negative electrode 145 are an example of an electrically conductive member. The first members 111, the second members 121, and the third member 131 can be disposed at desired positions of the ground 143, the positive electrode 144, and the negative electrode 145. More specifically, the first members 111, the second members 121, and the third member 131 are inserted into the slide rail 141 from the upstream side or the downstream side in the X direction. Thus, the slide rail 141 holds the first members 111, the second members 121, and the third member 131 such that the positions of the members can be adjusted in the X direction, in a state where the members 111, 121, and 131 are in contact with the ground 143, the positive electrode 144 and the negative electrode 145. Therefore, electricity is supplied to the LEDs 112, which are provided at desired positions in the X direction within a setting range of the ground 143, the positive electrode 144, and the negative electrode 145.

The ground 143, the positive electrode 144 and the negative electrode 145 are provided to the slide rail 141.

The ground 143 electrically connects the ground 133 and the ground 113 with each other. The positive electrode 144 electrically connects the positive electrode 134 and the positive electrode 114 with each other. The negative electrode 145 electrically connects the negative electrode 135 and the negative electrode 115 with each other.

As illustrated in FIG. 10, the primary power supply of the LED driver 132 is supplied with power from the outside with direct current (DC). When the negative electrode 145 is set to the reference potential, the ground 143 may be omitted.

As illustrated in FIG. 11, when hydroponic cultivation is performed using the installation tray 200 having a narrowest interval between the plants S in the X direction, only the first members 111 and the third member 131 are set in the slide rail 141.

When all the members are set in the slide rail 141, the ground 113 and the ground 133 are electrically connected to the ground 143. Further, the positive electrode 114 and the positive electrode 134 are electrically connected to the positive electrode 144, and the negative electrode 115 and the negative electrode 135 are electrically connected to the negative electrode 145. Current output from the LED driver 132 provided on the third member 131 flows to the LEDs 112 provided on the first members 111, thus causing the LEDs 112 to emit light.

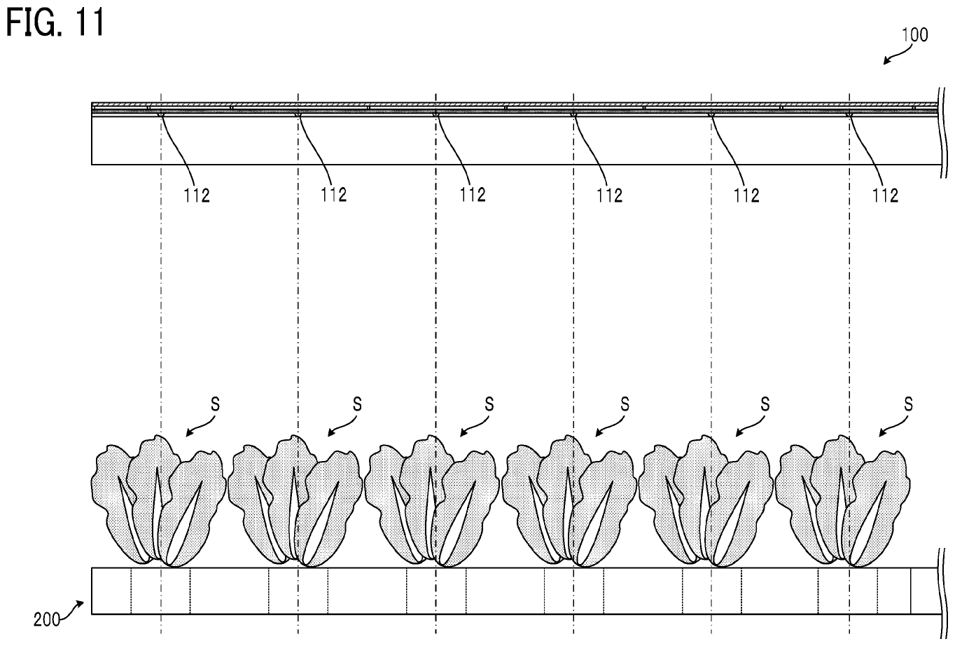

As illustrated in FIG. 12, when the plants to be cultivated grow and are transplanted to the installation tray 200 having a wider interval between the plants S, firstly, the first members 111 and the third member 131 are slid in the X direction to be removed from the slide rail 141. Then, the first members 111 and the second members 121 each having the width “a” that has been adjusted are alternately inserted into the slide rail 141 from the upstream side in the X direction. Alternatively, the first members 111 and the second members 121 can be inserted from the downstream side in the X direction.

The third member 131 can be set at any position in the X direction in terms of electrical connection. However, to arrange the LEDs 112 with even intervals therebetween, it is preferable to set the third member 131 at the end of the slide rail 141 in the X direction.

When all the members are set in the slide rail 141, the ground 113 and the ground 133 are electrically connected to the ground 143. Further, the positive electrode 114 and the positive electrode 134 are electrically connected to the positive electrode 144, and the negative electrode 115 and the negative electrode 135 are electrically connected to the negative electrode 145. Current output from the LED driver 132 provided on the third member 131 flows to the LEDs 112 provided on the first members 111, thus causing the LEDs 112 to emit light. By setting the second members 121 each having the width “a” that has been adjusted in the slide rail 141, the interval between the LEDs 112 can be easily extended. Thus, the LEDs 112 are accurately positioned.

In order to further widen the interval between the LEDs 112, the first members 111 and the second members 121 are slid to the upstream side or the downstream side in the X direction to be removed from the slide rail 141. The third member 131 is removed from the slide rail 141 as needed. Then, the first members 111 and the second members 121 each having the wider width “a” are inserted into the slide rail 141. Thus, the interval between the LEDs 112 can be easily widened, and the LEDs 112 are accurately positioned. Similarly, to narrow the interval between the LEDs 112, the second members 121 are replaced with the other second members 121, each having the narrower width “a”.

As described above, the LEDs 112 can be arranged directly above the plants S by flexibly changing the interval between the LEDs 112 in accordance with the change of the interval between the plants. Thus, light emitted from the LEDs 112 is effectively used for cultivation of plants.

Further, since the first members 111, the second members 121 and the third member 131 can be removed individually, when the light decreases, malfunction, total failure or the like occurs in a certain LED 112, only the first member 111 including the certain LED 112 is replaced.

The interval between the LEDs 112 is set to a desired width by various combinations of the first members 111 and the second members 121, thereby affording a high degree of design flexibility.

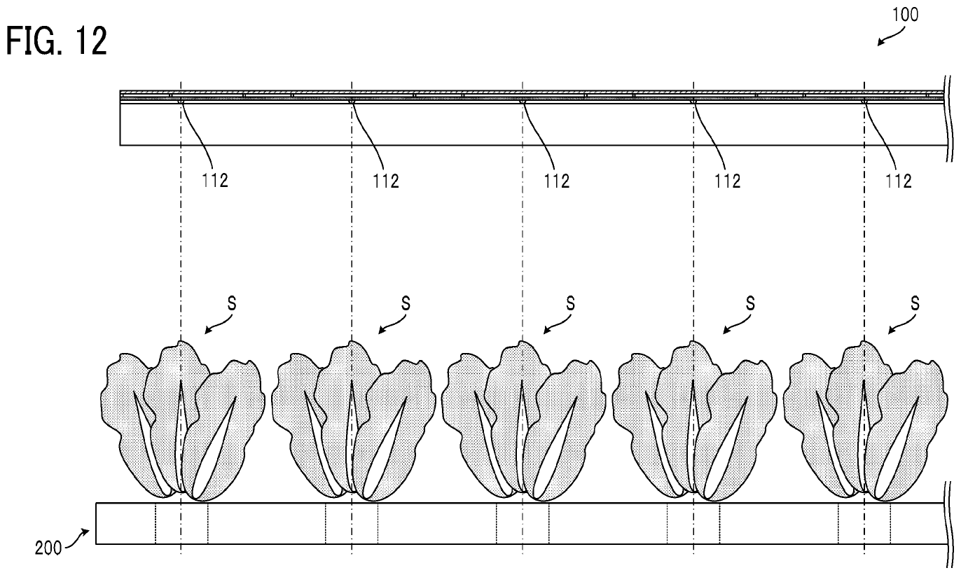

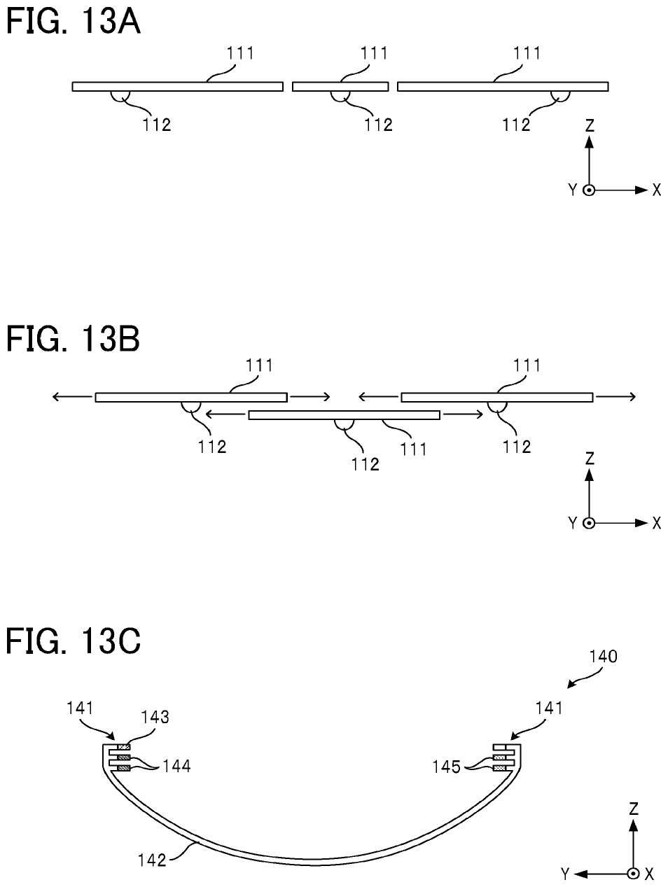

In the present embodiment, the description given heretofore is of a case where the interval between the LEDs 112 in the X direction is adjusted by using the second members 121. Alternatively, as illustrated in FIG. 13A and FIG. 13B, the interval between the LEDs 112 in the X direction can be adjusted even when only the first members 111 are used.

For example, as illustrated in FIG. 13A, the interval between the LEDs 112 can be adjusted by using the first members 111 including the LEDs 112 at different positions in the X direction from each other.

In another example, the interval between the LEDs 112 can be adjusted by using the slide rail 141 having an upper story and a lower story as illustrated in FIG. 13C and arranging the first members 111 in the two stories such that the first members 111 arranged in the upper story and the first members 111 arranged in the lower story can slide independently as illustrated in FIG. 13B. In this case, the slide rail 141 holds the first members 111 such that they overlap with each other by a specific distance in the X direction. The specific distance can be appropriately changed in accordance with the interval between the plants S.

As described above, in the configuration example illustrated in FIG. 13A to FIG. 13C, the interval between the LEDs 112 in the X direction can be adjusted without using the second member 121 as a spacer.

In the present embodiment, the description given heretofore is of a case where the LED driver 132 is provided on the third member 131. Alternatively, the LED driver 132 can be provided on the first member 111 or the second member 121. However, it is preferable to provide the third member 131 on which the LED driver 132 is mounted, separately from the first member 111 and the second member 121, because the LEDs 112 need to be replaced as they deteriorate while the third member 131 on which only the LED driver 132 is mounted can be used for a long time.

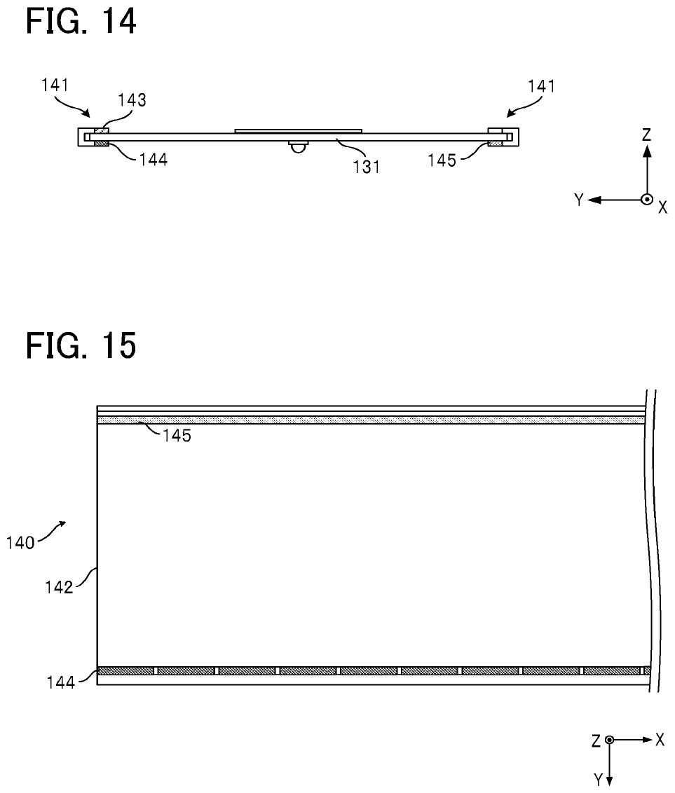

In the present embodiment, the description given heretofore is of a case where the slide rail 141 and the cover member 142 constitutes the case 140 as a single unit. However, this is just one example of the case 140. Alternatively, as illustrated in FIG. 14, the slide rail 141 can be an independent unit.

In the present embodiment, the description given heretofore is of a case where the LEDs 112 are electrically connected in parallel. Alternatively, the LEDs 112 can be connected in series.

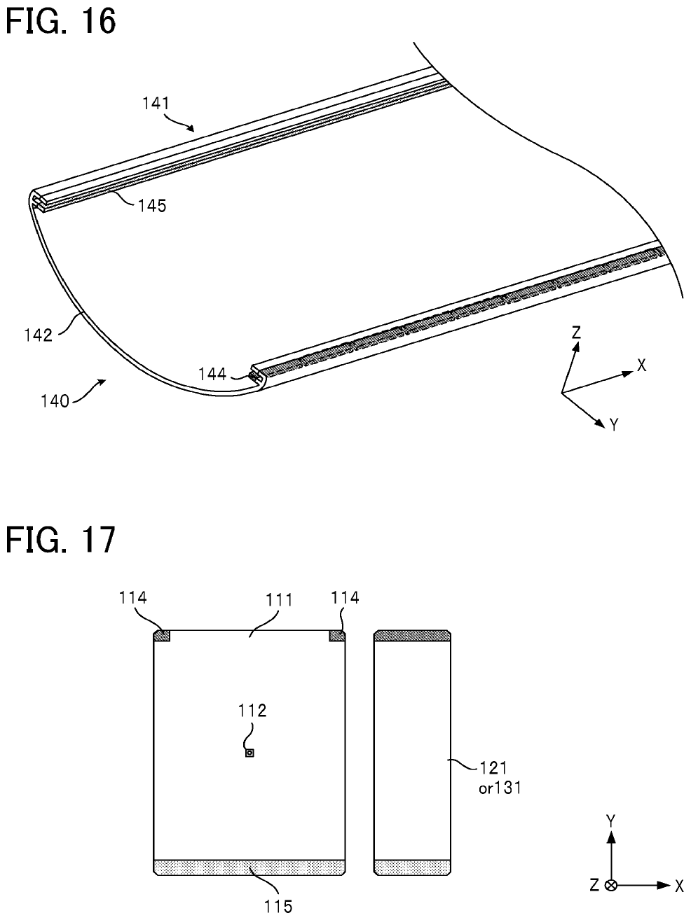

To connect the LEDs 112 electrically in series, as illustrated in FIG. 15 and FIG. 16, plural positive electrodes 144 or plural negative electrodes 145 of the slide rail 141 are arranged intermittently at regular intervals. FIG. 15 and FIG. 16 each illustrates a case where the positive electrodes 144 are arranged intermittently. Adjacent electrodes are not electrically connected.

As for the electrodes of the first member 111, as illustrated in FIG. 17, two positive electrodes 114 or two negative electrodes 115 are provided at both ends of the first members 111. FIG. 17 illustrates a case where two positive electrodes 114 are provided at both ends of the first member 111. There is no electrode in a space between the positive electrodes 114 arranged at both ends. In other words, the positive electrodes 114 provided at both ends are not electrically connected.

Each of the second members 121 and the third member 131 are provided with a positive electrode and a negative electrode, each being continuous. In other words, the two electrodes are continuous and electrically connected.

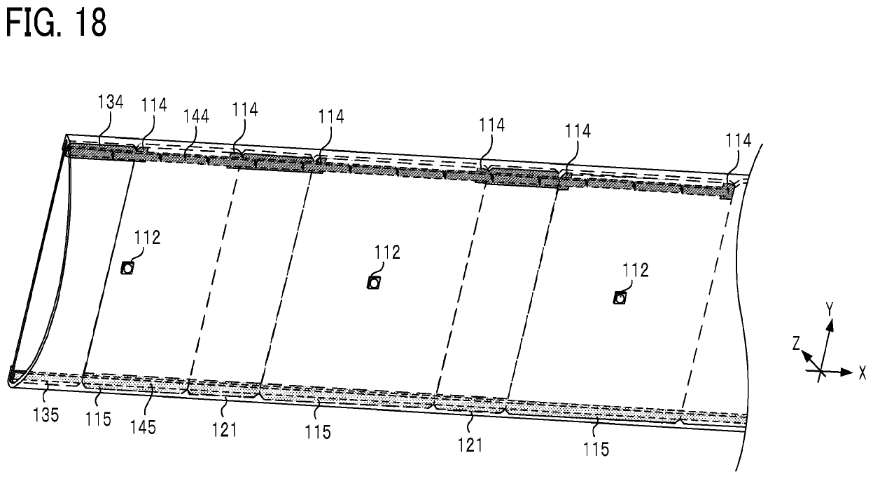

FIG. 18 illustrates a state in which the first members 111, the second members 121 and the third member 131 are set in the slide rail 141.

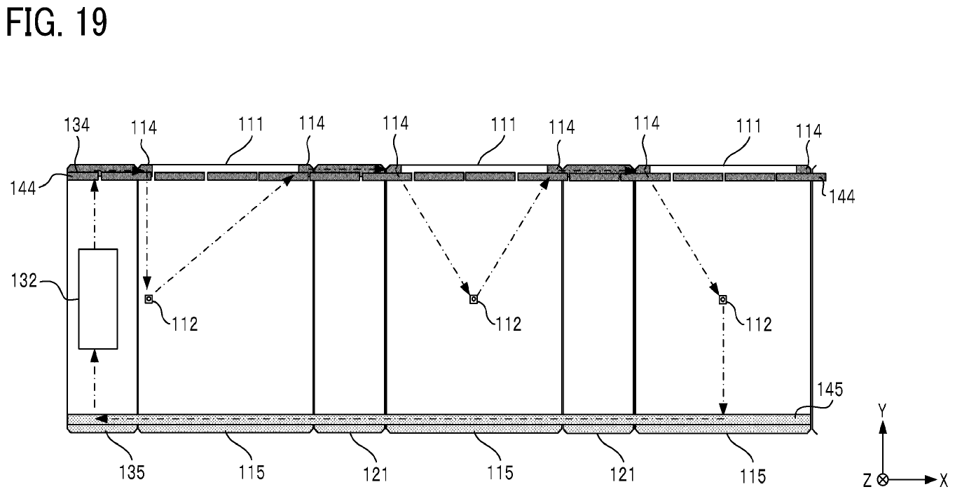

By setting the first members 111, the second members 121, and the third member 131 in the slide rail 141, the LEDs 112 are connected in series as illustrated in FIG. 19. In FIG. 19, the dot-and-dash arrow indicates the circuit wiring on the first members 111, the second members 121 and the third member 131 and the connection state of the electrodes when the first members 111, the second members 121 and the third member 131 are set in the case 140.

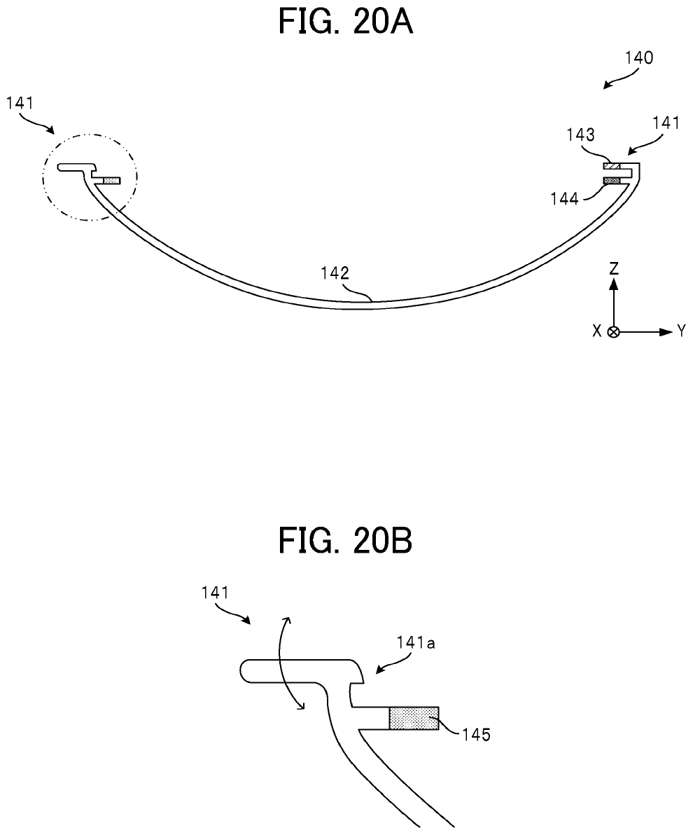

FIG. 20A and FIG. 20B illustrate a variation of the slide rail 141. FIG. 20A is a cross sectional view of the case 140. FIG. 20B is an enlarged view of the slide rail 141, which is a portion encircled by the two-dot chain line in FIG. 20A. As illustrated in FIG. 20A and FIG. 20B, the slide rail 141 includes a detachment mechanism 141a that allows the first member 111, the second member 121, and the third member 131 held by the slide rail 141 to be detached from the slide rail 141. The detachment mechanism 141a is a so-called snap-fit mechanism made of elastic resin.

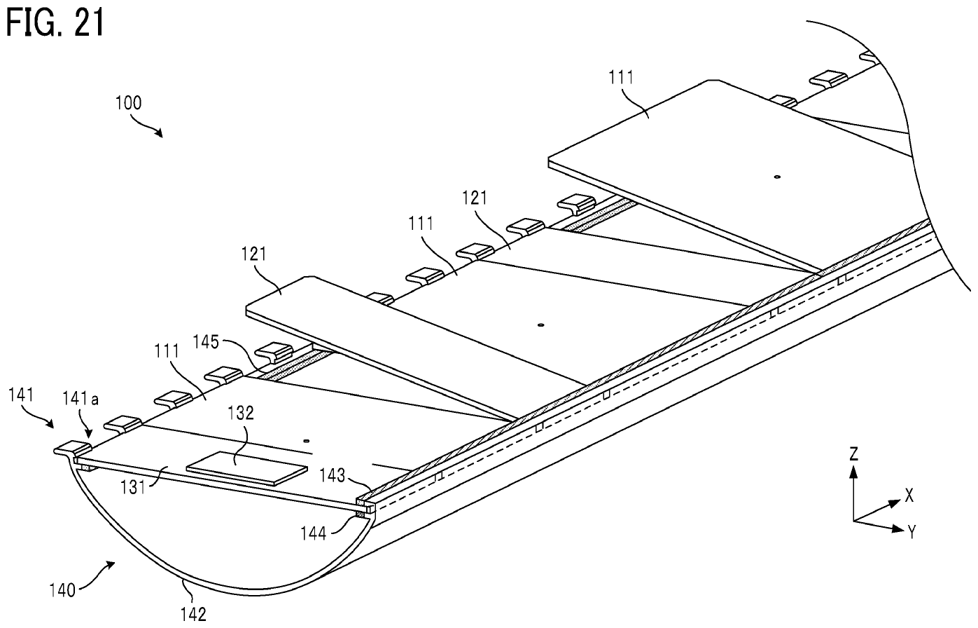

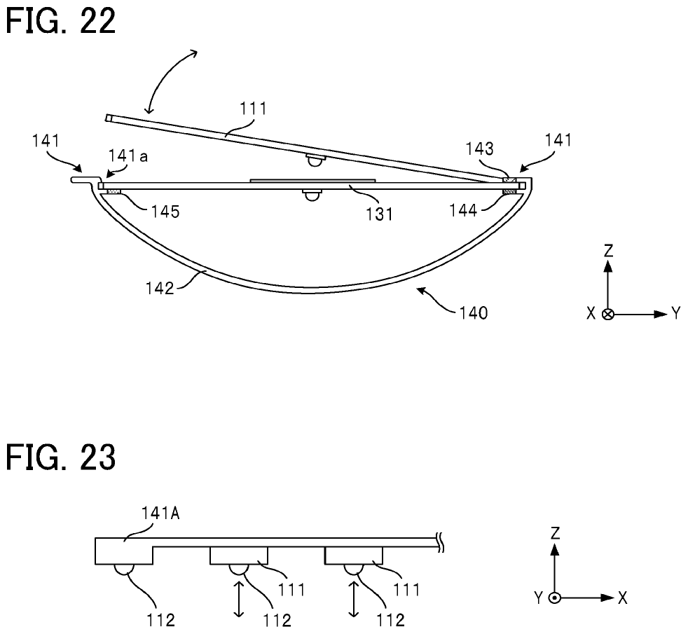

In the above-described example, the first members 111, the second members 121 and the third member 131 are set in the slide rail 141 by inserting the members alternately into the slide rail 141 from the upstream side or the downstream side in the X direction. Further, in the above-described example, the first members 111, the second members 121 and the third member 131 are pulled out from the slide rail 141 from the upstream side or the downstream side in the X direction. By contrast, in this variation, as illustrated in FIG. 21 and FIG. 22, since the slide rail 141 includes the detachment mechanism 141a, any one or more of the first members 111, the second members 121 and the third member 131 can be set and removed in and from the slide rail 141 from the downstream side in the Z direction, without moving the members in the X direction. Accordingly, any desired one or more of the first members 111, the second members 121 and the third member 131 can be replaced, without removing other member(s) provided closer to the end of the slide rail 141 than the member or members to be replaced. Further, the first members 111 can be accommodated at desired positions in the X direction without using the second members 121.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

For example, as illustrated in FIG. 23, a reflecting plate including the LED 112 is integrated with a set of holders illustrated in FIG. 3 as being interposed between the holders to constitute a holder 141A. The holder 141A may be configured to detachably hold the first members 111 can at desired positions. In this configuration, the second member 121 may not be used, and light from the LEDs 112 can be reflected between the LEDs 112 and the LED 112 toward the plants S.

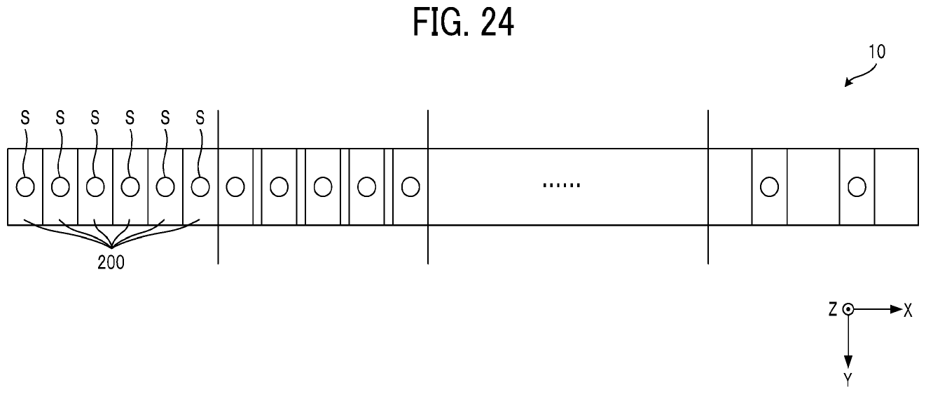

In addition, although in the above a description is given of a case where the intervals between the LEDs 112 are even, the intervals between the LEDs 112 may not be even, when the intervals between the plants S are not even. In the above description, the installation tray 200 that can accommodate the plurality of plants S to be cultivated is used, the plants are transplanted to the installation tray 200 having a wider interval between the plants S in the X direction in accordance with the growth state of the plant S. In another example, as illustrated in FIG. 24, the plants S are arranged respectively in the plurality of installation trays 200. In this case, the plurality of installation trays 200 is moved from the upstream side to the downstream side in the X direction to have a space therebetween according to the growth stated of the plants S. When this configuration is adopted, the first members 111, the second members 121, and the third member 131 can be arranged such that the interval between the LEDs 112 increases from the upstream side to the downstream side in the X direction.

In plant cultivation using a light-emitting device including light emitting diodes (LEDs) each being a light source for irradiating plants with artificial light, it is preferable that each plant to be cultivated be arranged directly under each of the LED light sources to efficiently use light emitted from the LED light sources.

In the related art, a technique of changing the size of the entire light emitting device has been proposed. However, in the related art, easy adjustment of the interval between LED light sources is not achieved. In other words, in the related art, even when the interval between plants increases as the plants grow, the interval between the LED light sources is fixed. Thus, light emitted from the LED light sources are not used efficiently.

According to one or more embodiments of the present disclosure, a cultivation system is provided in which an interval between light sources is easily adjusted according to the change of a pitch between plants, thus efficiently using light emitted from the light sources.

Although most preferable advantages are described above, advantages of the present disclosure are not limited to the advantages described above.

What is claimed is:

1. A cultivation system, comprising:
a light-emitting apparatus; and
an installation stand configured to accommodate a plurality of irradiation targets which are to be irradiated with light emitted from the light-emitting apparatus,
the light-emitting apparatus comprising:
a drive circuit;
an electrically conductive member connected to the drive circuit and extending in a predetermined direction;
a plurality of first members configured to be disposed at specific positions of the electrically conductive member, each of the plurality of first members including a light source; and
a holder configured to hold the plurality of first members in a state where the plurality of first members are disposed at the specific positions of the electrically conductive member,
the installation stand defining a plurality of installation place in which the plurality of irradiation targets are accommodated, respectively.

2. The cultivation system of claim 1,
wherein the electrically conductive member is provided to the holder.

3. The cultivation system of claim 1, further comprising:
at least one second member disposed at a specific position of the electrically conductive member and configured to reflect light from the light source.

4. The cultivation system of claim 3,
wherein the holder includes a detachment mechanism that allows at least one of the plurality of first members and the at least one second member held by the holder to be detached from the holder.

5. The cultivation system of claim 1,
wherein the holder is further configured to hold the plurality of first members slidably in the predetermined direction.

6. The cultivation system of claim 1,
wherein the holder is further configured to hold the plurality of first members such that the plurality of the first members overlap each other by a predetermined length in the predetermined direction.

7. A light-emitting apparatus comprising:
a drive circuit;
an electrically conductive member connected to the drive circuit and extending in a predetermined direction;
a plurality of first members configured to be disposed at specific positions of the electrically conductive member, each of the plurality of first members including a light source; and
a holder configured to hold the plurality of first members in a state where the plurality of first members are disposed at the specific positions of the electrically conductive member.
